(19) United States
(12) Patent Application Publication
(10) Pub. No.: US 2026/0007981 A1
(43) Pub. Date: Jan. 8, 2026

(54) PUBLIC HEALTH PRODUCTS BASED ON LEGO BLOCKS

(71) Applicant: HOWARD ZUCKER, Bronx, NY (US)

(72) Inventor: HOWARD ZUCKER, Bronx, NY (US)

(21) Appl. No.: 19/248,240

(22) Filed: Jun. 24, 2025

Related U.S. Application Data
(60) Provisional application No. 63/667,566, filed on Jul. 3, 2024.

(51) Int. Cl. A63H 33/08; G09B 23/34

(52) U.S. Cl. CPC A63H 33/086; G09B 23/34

(57) ABSTRACT

A novel modification of a popular toy product line generally made available under the name “LEGO” brand products features distinctive shapes and designs that help to mimic and explain various aspects of issues well known in Public Health Circles. The LEGO PUBLIC HEALTH PRODUCT line disclosed herein features inventive shapes and interconnections that will allow children and adults alike to playfully explore and gain a better understanding of health and disease including infection, bone breakage and repair, tooth growth and replacement and a vast landscape of other body processes. Different shapes, colors and designs are set forth for different agents, including pathogens of different varieties, and a number of natural body processes. These are all designed to interest and involve children as well as a adults in the creation of a wide variety of LEGO-based structures, devices and combinations.

### PRIORITY DATA AND INCORPORATION BY REFERENCE

This Application claims benefit of priority of U.S. Provisional Patent Application Ser. No. 63/667,566, filed Jul. 3, 2024 which is incorporated by reference in its entirety.

### BACKGROUND OF THE INVENTION

Millions of children, over the course of multiple generations, have spent countless hours playing with a rainbow spectrum of thousands of Lego bricks. (LEGO and derivatives of that mark are the subject of many trademarks and copyrights. LEGO bricks, as first illustrated in U.S. Pat. No. 3,005,282, incorporated herein by reference, are generically referred to herein as Legos and Lego bricks.) Children working with Legos learned about aerospace, history, architecture and engineering. They learned how to use their imagination to build and create, to explore and dream. As a pediatrician and public health expert (and father of two young children), a silver lining from the recent pandemic is an increased interest on the part of children in how their body works. The STEM curriculum is often enhanced using LEGO bricks and this marriage of education and entertainment supports a new product line for LEGO which will generate incredible interest and financial return on investment.

A public health and medicine line will inspire children to imagine the possibilities about better health while encouraging them to enhance their knowledge of wellness. It will also generate incredible interest among parents who will view these LEGO sets as a useful strategy for their youngsters to better understand their growing bodies. Just as children play with the space collection at LEGO and dream to go to the stars, wonder about the amazing feats of architecture and design across the globe, they will seek to explore how we remain healthy and well while understanding the intricacies of the human body.

### THE PRODUCT LINE

To focus on age groups as noted in other product lines, the collections can be simpler with larger and fewer pieces for those under age 6 and become more complex as they age. It is probable that all the pieces required for this product line are already manufactured by LEGO and can be assembled into specific kits.

Three initial collections are easily identified. This invention is not limited to these collections or product lines, which spread in almost infinite diversity. But they offer a starting point, a grounding, which can be the basis for immediate introduction of this collection, followed by further development. In general, the “starting points” or collections comprise Lego bricks collected to reflect certain elements that can be connected to make objects that may reflect various aspects of medicine and technology. Those collections are first discussed, below.

### The Pathogens

How many times has a child heard the phrase—‘you have a cold and need to rest.’ But what does a child understand about a cold and what the viruses look like? There are a few key ones that should initially be included in separate and combined kits or collections.
a) Rhinovirus

Rhinovirus is the primary cause of a child's common cold. The virus has many small spherical components attached to stalks that attach to the central core. These can be of a variety of colors based on how they stain under the microscope but LEGO bricks of yellow, orange, blue and purple can be pieced together attaching to a brown central ball that is no longer visible once the smaller spheres are added.
b) Influenza

Influenza virus is the cause of flu outbreaks every winter. It is highly contagious and children are aware of adults saying that someone has ‘the flu.’ Individual blue and red stalks attached to a brown shell with four pieces of ¼^{th} of a sphere shape would be assembled with each stalk. The virus model could be designed to open, and one can see the duplicating green rings of RNA (the reproducing blueprint of the virus). These would be put together in a coil shape attached to a purple shell that is adhered to the brown shell that the stalks click on to. Since these viruses replicate frequently and invade cells to spread disease, they could have attachment pieces that click onto the Cell model which is explained in the next section or collection.
c) Coronavirus

Every child of age 7 or older has some recollection of the pandemic. Others will learn about it in school. The Covid-19 virus will remain a most historical image on par with the Saturn V rocket, the Corvette, the Titanic and other Lego classics. The virus model would include the classic gray honeycomb shell which when opened would show the critical structures to the virus including its replicating material and the capsule, the proteins including the stalk, the sheath, the tail fibers and spikes. The spike protein would be made of cylindrical pieces in triplet attached to each other that are of smaller dimensions. The smallest triplet would attach to a three (red) balloon shapes (head of the protein) on one side and then to another triplet on the other side. That triplet would be a little longer and it would attach to another one (a little longer) and finally a fourth one (also a little longer). These spike proteins would all be plugged into the honeycomb shell. Unlike rhinovirus or influenza, one could see the shell of the coronavirus rather than it being covered with viral stalks. This would result in many small pieces attaching to the sphere. The virus could be opened to see the RNA (in yellow), that would require a strand that attaches to the inside of the shell. It would be made of rectangular pieces that click into a backbone and the entire line of RNA would slowly twist as it is put together so that it fits inside the sphere that is the core of the virus. Other parts of the Covid-19 virus would include different types of proteins that are on the surface. The shell would be made up of multiple layers. The spike protein would be able to attach to the human cell through a flexible piece that clicks into the surface of the human cell model.

Though there are many other viruses and bacteria that could be developed, it would be beneficial to start with these three critical ones. The bacteria that cause ear infections, stomach bugs, and sore throats would all be of interest to children but could be for the second generation of models. If there is less of an interest to highlight the coronavirus, then a similar level of detail can be provided for the routine common cold virus (rhinovirus),

### The Body

To put the pathogens into context and for children to understand how the body works, it would be beneficial to have several collections that focus on human physiology. Initial ones should tie to the child's curiosity as well as linked to normal childhood occurrences
a) The Cell

Children are constantly told about how their bodies, and all living things, are made up of cells. The word ‘cell’ is used in many contexts and children hear it frequently. For them to better understand the “cell”, a kit which captures all the workings of a human cell would fascinate children of all ages. It would be made of a shell (multiple colors are possible) with a flat surface but of varying shapes (the membrane of the cell). The more interesting part will be the inside which will have components that click into the cell wall which is made of flat green pieces laid out. The nucleus of the cell would be a ball inside the cell, and it would have interlinking helical pieces of 4 colors (red, blue, green, and yellow) that click together representing DNA. These pieces would be flat but only two colors (red and blue; and then yellow and green) that can connect with each other. In essence the red could not connect with the yellow or the blue with the green. This would be coiled and attach to the wall of the nucleus of the cell. Outside the nucleus but inside the cell would be the energy box (mitochondria) to the cell. This would be two half cylindrical pieces that click together and have a ribbon-like coil inside (like the RNA design in the Covid-19 virus). That could snap onto the flat surface inside the cell. A maze-like collection of pieces would form a wavy line with small circular balls that are scattered about the surface attaching to it in some parts and not in others (endoplasmic reticulum, smooth and rough). This would attach to the inside wall as well. Similarly, half shells of increasing size (Golgi apparatus) would attach to one another and then attach to the maze-like collection noted previously. Since the cell is filled with fluid, a more sophisticated model could use clear pieces that fill in the rest of the inside of the cell. On the surface would be attachment points for viruses to click into, as viruses work by invading cells.
b) The Tooth

Every elementary school child is fascinated with how their teeth grow, fall out, and a new one comes in. The tooth is a very complex part of our body and would be of great interest to children. It is rarely captured in any toys for children. The tooth model would be made of spherical pieces that start by capturing the nerve and blood vessels that run from the bone into the tooth. These would be tall interconnected red (artery), blue (vein) and yellow (nerve) pieces. Regular beige pieces of multiple shapes and sizes would form the dentin and white curved pieces would represent the enamel with flat beige pieces on the top. The enamel would cover the side of the tooth to the bottom where the red and blue tall pieces, representing the vessels, would exit the tooth.
c) Bone

Children in the early years often know of someone who has broken a bone in the playground or have done so themselves. After the pain has resolved, they are often fascinated by their cast and seeing the X-ray of their broken bone. Moreover, they are fascinated by skeletons that they see in museums. The latticework of bone is made of interwoven cells with a very orchestrated pattern. Bone cells keep replacing themselves and it may be possible to represent this remodeling through the kits. The initial set should be of the humerus or radius (upper arm) or the hand. The hand would be more intriguing as there are 10 small bones and many little bones that would click together. The design would include beige pieces that can represent the bone lattice. If the hand is the preferred model, then there would be 5 small bones at the tips of each finger which would click into a flat white plate representing the growth plate. That would click into a larger cylindrical collection of beige pieces which represent the next part of the fingers and similarly the end of that part would require some oval shaped pieces which click into a flat plate and connect to the third part of the digits. They would connect into ten bones which would require multiple pieces of different shapes and sizes and flat white pieces that cover the 10 small bones to represent the spaces between the small bones. These would then connect to the last large piece which would be a combination of multiple pieces ultimately forming a trapezoid shape to represent the lower part of the forearm bone (radius). There is more that could be added to the hand model that would include blood vessels, tendons, nerves and muscles but that may be too elaborate. And the focus is to show the bone anatomy which is of interest to children.

Other models in the future could include the human heart, brain, and lungs along with the ear and nose (given how frequently children get upper respiratory illnesses). Moreover, it is possible to choose different first sets.

### The Response

Understanding how the body responds to an infection is of educational interest and should be part of the Public Health Product Series Line. The innate and adaptive immune system is how our bodies respond to any pathogen, virus, bacteria, fungus, or even exposure to a foreign substance. Children would be amazed at the ‘battle’ between foreign substances and our army of defense systems to fight back.
a) Antigen Antibody

These bricks would form the shape of a ‘Y’ as the antibody is designed with two chains of rectangular shapes. There is a short chain (called the Light Chain) and is made up of thin plates that in detail have many small spheres. These smaller spheres can be of any color and when linked together would form the rectangle. The longer chain (called the Heavy Chain) would have four parts. Two are similar to the light chain are parallel to that chain and the longer part is the section that forms the bottom part of the letter “Y”. All these chains are also made up of small spheres. When the body sees a foreign substance (called an antigen), be it infectious agent or a chemical that we are not familiar with, an antibody is made, and it clicks into the antigen. Then the body destroys that “antigen-antibody complex.” The bricks could also be designed to only click into certain viruses to demonstrate how our immune system works. The LEGO pieces would have movable elbows for the “Y” and the ends would not fit with the virus if it were the wrong antibody. The antigen binding sites would need to match perfectly with the antibody.
b) Vaccine Response

It would also be possible to develop a Lego model for how vaccines are designed and can work on activating the body's defense systems and how it gets ‘reactivated’ whenever we are exposed to the same ‘antigen.’
c) Food Allergies

Using bricks that represent foods (peanuts, shellfish, eggs, etc. . . . ) we can show how the body develops an allergy to common items that we eat.

There are many areas of interest that children have about their bodies and particularly when something goes awry. This is where the Lego ‘Public Health Product Line’ would be attractive to parents and children. Among some of the other areas of interest to children are, how our hair grows, what causes ear infections, and sore throats, as well as how our heart and brain work. The best approach at this point is to tackle the first series: ‘The Pathogens, The Body, The Response’ and then based on interest, can expand from there.

While the present invention has been disclosed both generically, and with reference to specific alternatives, those alternatives are not intended to be limiting. This application only begins to touch on the various alternatives supported by the Lego PUBLIC HEALTH PRODUCTS LINE. Those of ordinary skill in the art will recognize that there are endless variations and possibilities that can be provided along the lines set forth above, without departing from the core or spirit of the invention.

What is claimed is:

1. A toy to assist children in imagining features of the human body and aspects of its interactions with microscopic elements, wherein said toy is comprised of one or more collections of interlocking bricks that can be snapped or pressed together to form devices intended to represent at least one of three collections, said collections selected from the group consisting of blocks that can be assembled to represent pathogens related to the human body, physical features common to the human body and responses of the human body to infection by pathogens, wherein said collections are comprised of said interlocking bricks selected to characterizes said collections.

2. The toy of claim 1, wherein said collection comprises interlocking bricks which together can be assembled to illustrate a pathogen selected from the group consisting of rhinovirus, an influenza virus or a corona virus, said interlocking bricks featuring colors comprising yellow, orange, blue, purple and brown.

3. The toy of claim 1, wherein said collection comprises interlocking bricks which together can be assembled to illustrate a human body part selected from the group consisting of a human cell, a human tooth, a human bone, a human heart, a human brain, a human lung, a human nose and a human ear, said interlocking bricks, when assembled to reflect said body part feature colors comprising red, brown, green and yellow.

4. The toy of claim 1, wherein said collection comprises interlocking bricks which together can be assembled to illustrate a response by the human body to infection of the human body, wherein said response comprises a human antibody to an antigen.
